(19) United States
(12) Patent Application Publication
(10) Pub. No.: US 2025/0095941 A1
(43) Pub. Date: Mar. 20, 2025

(54) MY BREAKERS

(71) Applicant: Jamie Wallrich, Cullom, IL (US)

(72) Inventor: Jamie Wallrich, Cullom, IL (US)

(21) Appl. No.: 18/369,161

(22) Filed: Sep. 16, 2023

(51) Int. Cl. H01H 71/04; H01H 71/70

(52) U.S. Cl. CPC H01H 71/04; H01H 71/70; H01H 2071/048

(57) ABSTRACT

A comprehensive software tool designed to revolutionize manually switching of circuit breakers by providing a Breaker APP on a mobile device that can move through several locations, including residential addresses, to switch circuit breakers in real time from any mobile device with the APP. The tool addresses several pain points and challenges faced by agricultural industry professionals and aims to streamline operations, enhance customer experiences, and maximize efficiency throughout the remote accessing of breaker circuits.

### FIELD OF THE INVENTION

The invention relates to An APP on a mobile device used to trip breakers of grain bin machinery

### BACKGROUND OF THE INVENTION

A circuit breaker is a device which provides on/off control to an electrical line. Traditional circuit breakers are spring loaded. There is an element inside the breaker that heats up when there is too much current and the element changes shape and springs back like a mouse trap. The electrical line may be connected to a load, such as an appliance, lighting, machinery, or the like.

In the past, or even current times, agricultural or residential circuit breakers are manually switched. Emergency situations, such as storms, fires, darkness may preclude switching of circuit breakers to the detriment of the system. Grain bins often contain 15,000 bushels of grain. Oftentimes the grain in the bin may need to be stirred, by a huge stirrator. Or maybe the grain needs spreading or to be unloaded. All of these functions and more, are turned on and off via each individual and corresponding circuit breaker. Agricultural workers often work 35 bin sites across hundreds of miles of farmland. And each bin site can have as few as 3 or as many as 7 bins. And each bin has 7 circuit breakers within each and every breaker box. With only 3 bins, there are 21 circuit breakers, just at that one site. So agricultural workers travel hundreds of miles between these bin sites, usually 20 miles apart, daily, flipping these hundreds of circuit breakers. Sometimes, a worker will not remember if they turned off the spreader at one bin site, but they are miles and miles away from that bin site and don't want to have to drive back over there to check to see if they had turned it off.

Removing existing circuit breakers from a breaker box and replacing them is easily and safely done as the breakers swing off the power rail in the breaker box, and once the circuit breaker is off the power rail there is no risk of getting electrocuted. Then the two wires must be unhooked and the circuit breaker may now be switched.

There is a little orange lever, within the circuit breaker, behind a screen on the face of the circuit breaker, that moves in front of the screen when the breaker is switched.

It is an object of this invention to add an electric motor to the circuit breaker to control said circuit breaker. The electric motor will be responsive to a signal from a remote Breaker APP on a mobile device. Through this Breaker APP, the agricultural worker can remotely, turn on and off any circuit breaker. The circuit breaker also has a sensor inside, sensing whether or not current is flowing in said circuit breaker, thereby detecting whether the machinery is on or off, once the circuit breaker has tripped.

Another object of this invention is the registration of each and every remotely accessed circuit breaker with the Breaker APP on the mobile device. There is a Settings function on the opening screen of the Breaker APP. This is where the user enters the serial number of the circuit breaker and then adds which piece of machinery it controls, then if located in a bin, what bin the piece of machinery is located in and then the location of the bin. Similarly, once the serial number of the circuit breaker is entered, if the machinery is not in a bin, such as when it's an appliance at a residence, or a compressor at an outpost, then the user enters which piece of equipment the circuit breaker is controlling and then enters the location of the equipment.

### SUMMARY OF THE INVENTION

My Breakers is an electronic motor located either within each and every circuit breaker, or a separate motor tacked onto each and every circuit breaker for forcing the circuit breaker to switch upon a signal that the circuit breaker receives remotely from an APP on a mobile device. If the motor is tacked on to each and every circuit breaker, the separate motor may occupy two rectangles or spots on the circuit breaker circuit panel. There is also a sensor within the circuit breaker to sense whether or not current is flowing through the machinery which is controlled by the circuit breaker. Each circuit breaker that is to be controlled by the Breaker APP on the mobile device, must be registered with the Breaker APP via a serial number, distinct for each and every circuit breaker.

My Breakers is a comprehensive software tool designed to revolutionize manually switching of circuit breakers by providing a Breaker APP on a mobile device that can move through several locations, including residential addresses, to switch circuit breakers in real time from any mobile device with the APP. The tool addresses several pain points and challenges faced by agricultural industry professionals and aims to streamline operations, enhance customer experiences, and maximize efficiency throughout the remote accessing of breaker circuits.

One of the core features of the Breaker APP is its ability to provide instant access to crucial information, eliminating time-consuming delays and improving decision-making. The tool ensures that agricultural workers and their clients have all the necessary information at their fingertips, starting from the first page selecting a location of said breaker box.

By leveraging the Breaker APP, users gain access to a vast repository of bin locations, bin selections within those locations, and circuit breaker selections within those bins. This comprehensive and quickly available information empowers users to make informed decisions, saving valuable time for agricultural workers.

Furthermore, Breaker APP addresses the issue of storm and cell tower pillage, and any other reason a breaker circuit must be switched and doesn't get switched. It serves as a handheld guide, providing real time breaker circuit switching, and is a reliable resource for agricultural workers. With this tool, users can ensure that the breaker circuit that needs switching gets switched, immediately thereby serving customers effectively. If an agricultural worker desires to attend a wedding, and he just wanted to put air into a bin for 4 hrs, if he had the APP and the circuit breaker with the electrical motor in

Additionally, Breaker APP addresses the challenge of traveling thousands of miles to and from locations and bin sites within the agricultural industry. Instead of traveling those thousands of miles, users can access the Breaker APP, a centralized platform that offers organized and prioritized information. The tool provides bin and residential locations, allowing users to switch on or off those circuit breakers needed in real time. This ensures a much more quickly learning process and empowers individuals to become instantly effective in the field. Furthermore, Breaker APP mitigates employee turnover, by making switching on and off circuit breakers remotely via said APP instead of driving thousands of miles and switching manually each and every circuit breaker. By allowing any agricultural worker access to the Breaker APP, the Breaker APP empowers them instantly with circuit breaker access remotely and in real time. This prevents disruptions in service and guarantees a consistently positive customer experience.

The circuit breaker, in order to be remotely accessed, must have an electronic motor either inside the circuit breaker or alongside the circuit breaker, thereby taking up two spaces on the circuit breaker panel. The electronic motor must be able to force the circuit breaker to switch and to have electronic transmission with a mobile device through an APP on a mobile device. The circuit breaker must also comprise a sensor, for sensing whether or not current is flowing or sensing how much current is flowing. Each remotely accessed circuit breaker must register a unique

Lastly, the Breaker App addresses the issue of inexperienced hires who may not know where all the bine sites are located or how many bins are located on each site. By providing the Breaker App, the tool reduces the number of new hires who quit within a short period due to insufficient knowledge. This helps owners of farms retain valuable talent and empowers agricultural employees with remote control over all the relevant circuit breakers that control operations on any farm from the start.

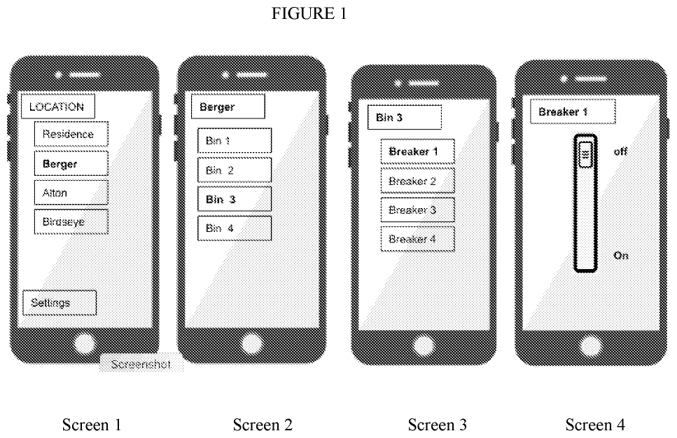

FIG. 1 shows a mobile phone as an example of a mobile device. Other mobile devices could be laptops, ipads, sensing devices etc. The mobile phone opens an APP called the Breaker APP and the APP opens to a Location screen. The Location screen lists farms, residences, outposts, anywhere a circuit breaker controlling a piece of machinery can be located. For illustration purposes only, the Berger farm is chosen and is shown highlighted to show it is chosen.

The Berger Farm, for only illustrative purposes, is shown on Screen 2, and lists all the bins by number that the Berger farm has at that bin site. We've listed 4 bins but only for illustrative purposes. The bins can be as few as one and many as 7 depending upon how many bins are located at the Berger farm location. Any of those bins can be chosen depending upon which machinery in which bin is needed to be turned on or off through the circuit breaker circuitry. Bin 3 is chosen as it is highlighted, so Bin 3 must have some piece of equipment, such a spreader, or a fan, or a stirrator or unloading needing to turn on or off via said circuit breaker.

Each and every circuit breaker to be remotely activated through this Breaker APP on a mobile device must be registered with the Breaker APP, the Breaker APP on that particular mobile device, via the Settings option of the first Location screen that the Breaker APP opens up to. Each and every circuit breaker that has circuitry in it to switch the circuit breaker electronically must have a serial number associated with it. The Settings feature of the Breaker APP will ask for a serial number that corresponds to each and every circuit breaker associated with what piece of equipment, in what bin that piece of equipment is working and where that piece of equipment is located.

Screen 3 opens to a list of the circuit breakers located within Bin 3. Each circuit breaker is either the fan circuit breaker or the stirrator circuit breaker or the spreader circuit breaker or the unloader circuit breaker, each circuit breaker associated with only one piece of equipment. By way of example, circuit breaker 1 is chosen which controls the Spreader (or any other piece of equipment). This circuit breaker 1 must have remotely activating switching circuitry within in (or alongside it) and have already registered with the Breaker APP previously for this this circuit breaker to show up on the Breaker APP.

Screen 4 opens to a switching circuit for circuit breaker 1, a sliding on off switch, where the user just slides their finger down or up on the face of the screen to turn on or off the piece of equipment.

Embodiments of this invention relate to methods and apparatus for controlling a farm's operation's needs. Certain tasks must be performed on a farm's bin sites that in the past have always been done manually. This Breaker APP on any mobile device, performs an overview of any farm via the bin sites and via the Breaker APP can access each and every registered circuit breaker, controlling the circuit breakers remotely, thus thereby runs the machinery in the bins remotely.

### BRIEF DESCRIPTIONS OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1. Screen 1 An example of the Breaker APP once opened on a mobile phone. The first page opens to a location screen.
Screen 2 Once a location is chosen, the next page chooses a bin.
Screen 3 Once a bin is chosen, the next page chooses a circuit breaker.
Screen 4 Once a circuit breaker is chosen, the last page switches the circuit breaker on or off.

### DETAILED DESCRIPTION OF THE INVENTION

The invention provides methods and apparatus for a circuit breaker with an electric motor, to be switched remotely.

In preferred embodiments of this invention, the circuit breaker is switched remotely by an APP on a mobile device.

In preferred embodiments of this invention, an agricultural worker uses a software program, My Breaker APP, to produce a menu of locations.

In preferred embodiments of this invention those menu of locations are bin site locations on a farm.

In another preferred embodiment, those menu locations are a residence.

In yet another preferred embodiment, once a location is chosen, which bin located on said site is chosen.

An exemplary embodiment of this invention, once a particular bin is chosen, the particular circuit breaker is chosen.

A preferred embodiment of this invention, once the circuit breaker is chosen, the machinery corresponding to said circuit breaker either turns on or off.

### Particular Applications to Computer Devices

The methods and apparatus applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

Aspects of the disclosed invention are described above with reference to methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

### Other Embodiments

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

1. An APP on a mobile device, that controls at least one circuit breaker, wherein said APP when opened, opens to a location choice screen.

2. The APP of claim 1, wherein once a location is chosen, the APP opens to a bin choice screen.

3. The APP of claim 2, wherein once a bin is chosen, the APP opens to a circuit breaker choice screen.

4. The APP of claim 3, wherein once a circuit breaker is chosen, the circuit breaker trips a particular chosen circuit breaker and turns on or off the corresponding machinery.

5. A circuit breaker circuit comprising an electric motor controlled remotely to switch said circuit breaker circuit and a sensor to sense current through said circuit breaker circuit to insure the circuit breaker circuit has been switched.

6. The circuit breaker of claim 5, wherein the electric motor is inside said circuit breaker.

7. The circuit breaker of claim 5, wherein the electric motor is attached to the outside of said circuit breaker.

8. The APP of claim 1, wherein one of the location selections is a residence.

9. The APP of claim 1, wherein one of the location selections is a bin site.

10. The circuit breaker of claim 5, wherein the sensor lies within said circuit breaker.

11. The circuit breaker of claim 5, wherein said electronic motor is controlled remotely via an APP on a mobile device.

12. The circuit breaker of claim 11, wherein the APP on the mobile device is Breaker APP, an APP dedicated to remote circuit breaking.

13. The circuit breaker of claim 11, wherein the APP contains a Settings function, wherein each and every circuit breaker must register with said APP through said Settings.
